(19) United States
(12) Patent Application Publication
(10) Pub. No.: US 2017/0324122 A1
(43) Pub. Date: Nov. 9, 2017

(54) SENSITIVE STRAIN-BASED SOC AND SOH MONITORING OF BATTERY CELLS

(71) Applicant: Ford Global Technologies, LLC, Dearborn, MI (US)

(72) Inventors: Eric POIRIER, Brownstown, MI (US); Tuyen Quoc TRAN, Dearborn, MI (US); Benjamin A. TABATOWSKI-BUSH, South Lyon, MI (US)

(21) Appl. No.: 15/145,221

(22) Filed: May 3, 2016

(51) Int. Cl. H01M 10/48; H01M 2/16; H01M 10/0525; H01M 10/0566; H01M 10/42

(52) U.S. Cl. CPC H01M 10/482; H01M 10/0566; H01M 2/1653; H01M 10/4257; H01M 2/162; H01M 10/0525; H01M 2010/4278; H01M 2220/20

(57) ABSTRACT

Battery packs and SOC monitoring systems are disclosed. The battery pack may include first and second adjacent battery cells and a strain gauge positioned between the first and second battery cells. A stress concentrator may be positioned between the strain gauge and one of the first and second battery cells. The stress concentrator may have a first surface contacting the strain gauge and a second surface opposite the first surface, and an area of first surface may be no greater than an area of the second surface. There may be three or more adjacent battery cells and two or more strain gauges and stress concentrators. A controller may be in communication with the strain gauge(s) and configured to receive strain data therefrom. The strain data may be used to determine a state of charge (SOC) and/or a state of health (SOH) of the battery cells or pack.

### TECHNICAL FIELD

The present disclosure relates to sensitive strain-based state of charge (SOC) monitoring of battery cells, for example, lithium-ion battery cells.

### BACKGROUND

Rechargeable or secondary batteries, such as lithium-ion (Li-ion) batteries may be used in many applications. Electric and hybrid electric vehicles (EVs) may use Li-ion batteries to provide some or all of the propulsive force for the vehicle. Accordingly, it is important to know how much energy is stored in the battery or battery pack. In order to provide for a reliable “fuel” gauge and/or driving range estimates, Li-ion battery packs require accurate state of charge (SOC) monitoring. Typically, SOC monitoring is performed using Coulomb integration or cell voltage measurements. Coulomb integration (or counting) generally involves integrating or aggregating the measured current in/out of a battery to give a relative value of its charge. In the voltage method, the SOC is determined based on measured battery voltage and the use of a voltage-SOC relationship curve or table. However, each of these methods may be subject to different limitations and inaccuracies.

### SUMMARY

In at least one embodiment, a battery pack is provided. The battery pack may include first and second adjacent battery cells; a strain gauge positioned between the first and second battery cells; and a stress concentrator positioned between the strain gauge and one of the first and second battery cells; the stress concentrator having a first surface contacting the strain gauge and a second surface opposite the first surface, the first surface having an area no greater than an area of the second surface.

A ratio of the area of the second surface to the area of the first surface may be at least 2:1, 5:1, or 25:1. A ratio of an area of a cell wall adjacent to the second surface to the area of the first surface may be from 10:1 to 50,000:1. In one embodiment, a long axis of the stress concentrator is the same or smaller than a length or a width of the strain gauge. The battery pack may include a spacer positioned between one of the first and second battery cells and the strain gauge. In one embodiment, the spacer may be positioned directly between one of the first and second battery cells and the second surface of the stress concentrator. In another embodiment, the spacer may be positioned directly between one of the first and second battery cells and the strain gauge. In one embodiment, the stress concentrator may be a triangular prism, a truncated triangular prism, a rectangular prism, a sphere, or a cylinder.

In at least one embodiment, a battery pack is provided. The battery pack may include first, second, and third adjacent battery cells; a strain gauge positioned between the first and second battery cells; and a stress concentrator positioned between the strain gauge and one of the first and second battery cells; the stress concentrator having a first surface contacting the strain gauge and a second surface opposite the first surface, the first surface having a smaller area than the second surface.

A ratio of the area of the second surface to the area of the first surface may be at least 5:1. The battery pack may include a spacer positioned between one of the first and second battery cells and the strain gauge. A second strain gauge may be positioned between the second and third battery cells. A second stress concentrator may be positioned between the second strain gauge and one of the second and third battery cells. The battery pack may include at least six adjacent battery cells and a plurality of strain gauges and each strain gauge may be positioned between two of the at least six adjacent battery cells. A ratio of battery cells to strain gauges may be at least 2:1 or 5:1.

In at least one embodiment, a strain-based state-of-charge (SOC) monitoring system is provided. The system may include first and second adjacent battery cells; a strain gauge and a stress concentrator positioned between the first and second battery cells; the stress concentrator having a first surface contacting the strain gauge and a second surface opposite the first surface, the first surface having a smaller area than the second surface; and a controller in communication with the strain gauge and configured to receive strain data therefrom.

The system may include at least five adjacent battery cells and a plurality of strain gauges. Each strain gauge may be positioned between two of the at least five adjacent battery cells and in communication with a controller. The controller may be configured to compare the strain data to a stored calibration curve or table. In another embodiment, the controller may be configured to estimate a battery SOC based on the strain data and monitor for battery cell degradation based on the strain data as a function of pressure.

### BRIEF DESCRIPTION OF THE DRAWINGS

FIG. 1 is a schematic cross-section of a rechargeable battery cell, according to an embodiment;

FIG. 2 is a perspective view of a battery cell module including a plurality of battery cells, according to an embodiment;

FIG. 3 is an exploded perspective view of a battery cell module including a plurality of cells and multiple strain gauges positioned between the cells, according to an embodiment;

FIG. 4 is an exploded perspective view showing a strain gauge and a stress concentrator positioned between two adjacent battery cells, according to an embodiment;

FIG. 5 is an end view showing a strain gauge and a stress concentrator positioned between two adjacent battery cells, according to an embodiment;

FIG. 6 is an end view showing a strain gauge and a stress concentrator positioned between two adjacent battery cells, according to another embodiment;

FIG. 7 is an end view showing a strain gauge and two stress concentrators positioned between two adjacent battery cells, according to an embodiment;

FIGS. 8A, 8B, 8C, and 8D are perspective views of several embodiments of a stress concentrator, including a first triangular prism, a second triangular prism, a stress concentrator having a curved edge, and a truncated triangular prism, respectively;

FIG. 9 is a schematic of a strain-based state of charge (SOC) monitoring system, according to an embodiment; and

FIG. 10 is a schematic diagram of a strain gauge connected to a microprocessor to analyze deformation or pressure of a battery cell.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

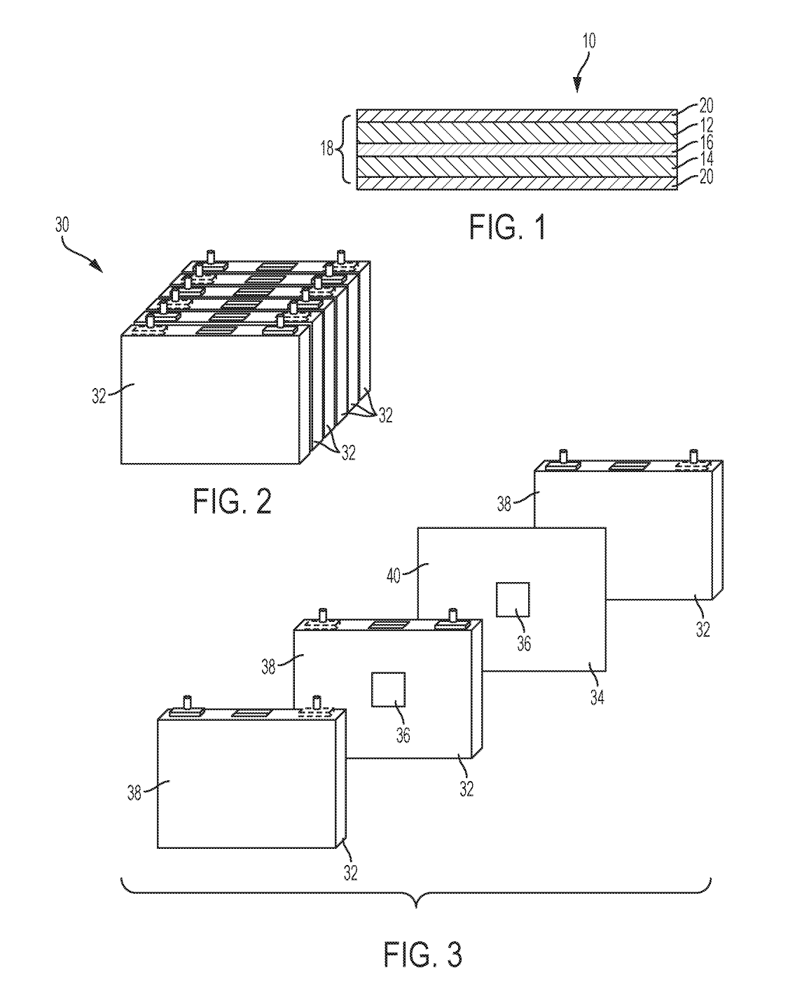

With reference to FIG. 1, a typical battery or battery cell 10 is shown, which may be a secondary or rechargeable battery (e.g., a lithium-ion battery). The battery 10 includes a negative electrode (anode) 12, a positive electrode (cathode) 14, a separator 16, and an electrolyte 18 disposed within the electrodes 12, 14 and separator 16. However, the battery 10 may include additional components or may not require all the components shown, depending on the battery type or configuration. In addition, a current collector 20 may be disposed on one or both of the anode 12 and cathode 14. In at least one embodiment, the current collector 20 is a metal or metal foil. In one embodiment, the current collector 20 is formed of aluminum or copper. Examples of other suitable metal foils may include, but are not limited to, stainless steel, nickel, gold, or titanium. The battery 10 shown in FIG. 1 is a schematic of a single cell, however, a battery pack may include a plurality of cells. Battery cells within a battery pack may be grouped into smaller units such as modules, arrays, or other sub-groups.

Li-ion battery anode active materials may be formed of carbonaceous materials, such as graphite (natural, artificial, or surface-modified natural), hard carbon, soft carbon, or Si/Sn-enriched graphite. Non-carbonaceous anode active materials may also be used, such as lithium titanate oxide (LTO), silicon and silicon composites, lithium metal, and nickel oxide (NiO). Li-ion battery cathode active materials may include lithium nickel cobalt aluminum oxide (NCA), lithium nickel manganese cobalt oxide (NMC), lithium manganese spinel oxide (Mn Spinel or LMO), lithium iron phosphate (LFP) and its derivatives lithium mixed metal phosphate (LFMP), and sulfur or sulfur-based materials (e.g., sulfur-carbon composites). In addition, mixtures of any of two or more of these materials may be used. These electrode active materials are merely examples, however, any electrode materials known in the art may be used. Li-ion batteries generally include a liquid electrolyte, which may include a lithium salt and an organic solvent. Examples of lithium salts may include LiPF₆, LiBF₄ or LiClO₄. Suitable organic solvents may include ethylene carbonate (EC), dimethyl carbonate (DMC), ethyl methyl carbonate (EMC), diethyl carbonate (DEC), or mixtures thereof. Li-ion battery separators may be formed of any suitable ionically conductive, electrically insulating material, for example, a polyolefin (e.g., polyethylene or polypropylene).

As described above, typical methods of determining SOC for Li-ion batteries include Coulomb integration or cell voltage measurement. The Coulomb integration method may be subject to errors associated with current sensors. Cell voltage measurement may be particularly challenging for Li-ion chemistry near the middle of the operating range due to a flat midrange voltage-SOC relationship (e.g., the voltage does not change significantly despite the SOC changing). Accordingly, additional approaches to determining a battery SOC that do not include these drawbacks may replace or supplement the typical methods.

In at least one embodiment, a sensitive strain-based approach to monitoring SOC is disclosed. The approach may include the use of one or more strain gauges to monitor the expansion and contraction of one or more cells in a battery back. Charging and discharging of a rechargeable battery (e.g., Li-ion) may cause the electrodes in the cell(s) to expand and contract. For example, the anode of a Li-ion battery (e.g., formed of graphite) may expand by about 10% upon anode charging (e.g., cell charging). The cathode of a Li-ion battery (e.g., formed of NMC) may expand by about 3% upon cathode charging (e.g., cell discharging). Stresses associated with the contraction and expansion of the electrodes may cause the cells to swell or deform. This cell deformation may offer an opportunity for battery SOC monitoring using one or more strain gauges.

With reference to FIGS. 2 and 3, a battery module 30 is shown including a plurality of battery cells 32. The battery module 30 may also be referred to as a battery group or a battery array. A battery pack may include one or more battery modules 30. In the embodiment shown, the cells 32 are prismatic cells, however, the battery module 30 may include other cell types, such as pouch cells. In FIG. 2, the cells 32 are stacked closely together, similar to an arrangement in a complete battery module. In FIG. 3, the cells 32 are shown in an exploded or spaced apart arrangement. A spacer or separator 34 may be disposed between adjacent cells 32. Only a single spacer 34 is shown in FIG. 3, between the middle and rear cells 32, however, a spacer 34 may be disposed between each pair of adjacent cells 32. The spacer 34 may have an area that is the same or similar to that of the adjacent cell walls. The spacer 34 may be any suitable material or structure for separating the cells 32, and may allow air or fluid flow between the cells for cooling.

In at least one embodiment, a strain gauge 36 may be positioned between two adjacent cells 32 in the battery module 30. If the cells 32 are prismatic cells having opposing relatively large walls 38, the cells 32 may be configured within the battery module 30 such that the large wall 38 of one cell 32 is directly adjacent to the large wall 38 of another cell 32 (except for cells at the ends of the battery module 30). In one embodiment, a strain gauge 36 may be positioned between two directly adjacent large walls 38 of two directly adjacent cells 32 (e.g., as shown in FIG. 3). The strain gauge 36 may be attached to either of the directly adjacent cells 32 (e.g., on a wall 38). If a spacer 34 is present between two directly adjacent cells 32, the strain gauge 36 may be attached to either a surface 40 of the spacer 34 that is parallel to a wall 38 of the cell 32 or to the wall 38 of one of the cells 32. The strain gauge 36 may be attached to the cell 32 or spacer 34 using any suitable means, for example, an adhesive, such as cyanoacrylate adhesives or epoxy adhesives.

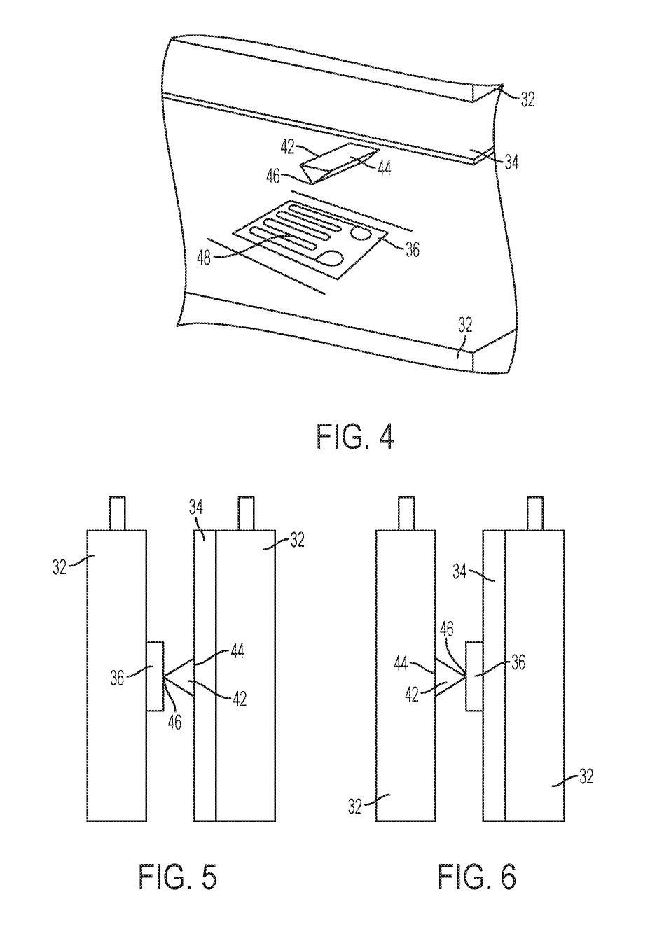

With reference to FIG. 4, an exploded perspective view of a strain-based SOC monitoring system is shown. The components in FIG. 4 are rotated relative to FIG. 3 for easier viewing, with the cells 32 spaced vertically apart. In the embodiment shown in FIG. 4, a spacer 34 is positioned between two directly adjacent cells 32. The strain gauge 36 is disposed between one cell 32 and the spacer 34. In the embodiment shown in FIG. 4, a stress concentrator 42 is included in the SOC monitoring system. The stress concentrator 42 is positioned between the strain gauge 36 and the spacer 34 in the embodiment shown, however, if the strain gauge 36 is attached to the spacer 34 then the stress concentrator 42 may be positioned between the strain gauge 36 and the cell 32.

The stress concentrator is small compared to the cell wall but may be sized to apply a localized force to the strain gauge's sensitive element(s). The stress concentrator may capture the force generated by cell expansion over the cell wall area and transfers a significant fraction of the force to a small area corresponding to the strain gauge sensitive element surface, thereby concentrating stress. Therefore, assuming a force F due to cell expansion, the force per unit area (or stress) applied to the area of the strain gauge without the stress concentrator is σ_{cw}=F/A_{cw}, where A_{cw} is the area of the cell wall on which the force is applied. The stress σ_{cw} is uniform across A_{cw}. In contrast, using the disclosed stress concentrator, the stress applied on the strain gauge is dependent on the area A_{sc} of the stress concentrator and is given by σ_{sc}=F/A_{sc}, where A_{sc}<<A_{cw}, assuming ideally that all the force is transferred to the stress concentrator. The stress σ_{sc} is thus, in principle, greater than that produced without the stress concentrator σ_{cw} by a factor A_{cw}/A_{sc}. In practice, due to factors such as deformation of the cell components (cell wall, spacer, concentrator), the concentration factor may not be exactly A_{cw}/A_{sc} but may be proportional to that quantity.

In at least one embodiment, the stress concentrator 42 may be configured to concentrate or amplify the stress or pressure exerted on the strain gauge 36. The stress concentrator 42 may have a first surface 44 configured to contact a wall 38 of a cell 32 or a surface 40 of the spacer 34 and a second surface 46 configured to contact the strain gauge 36. In one embodiment, the first surface 44 may have a larger area than the second surface 46. However, in another embodiment, the surfaces may have the same or similar area. Therefore, a force applied to the first surface 44 may cause the second surface 46 to apply a greater stress or pressure on the strain gauge 36. Accordingly, when a cell 32 deforms due to charging or discharging, the stress applied to the strain gauge 36 by the force of the deformation may be concentrated or amplified, which may amplify the resistive response of the strain gauge 36. The amplified resistive response of the strain gauge 36 may allow it to be more sensitive to small deformations of the cell walls, which may in turn allow more accurate monitoring of the SOC of the cell 32 and/or the overall battery module 30 as the cells expand and contract.

The strain gauge 36 may be any device able to detect the strain of the wall(s) 38 of the cell(s) 32. In at least one embodiment, the strain gauge may be a resistance-based strain gauge, as shown in FIG. 4. These strain gauges may operate on the principle that electrical conductance depends on the geometry of a conductor. If an electrical conductor is elastically stretched, it becomes narrower and longer, increasing its electrical resistance. Alternatively, if a conductor is compressed, it becomes wider and shorter, decreasing its electrical resistance. Therefore, by measuring the electrical resistance of the strain gauge, the amount of strain may be determined and the induced stress may be inferred. A strain gauge may include a long, thin conductive strip 48 in a serpentine or zig-zag pattern of parallel lines. The parallel lines may allow a small amount of stress in the direction of the orientation of the parallel lines to cause an amplified strain measurement over the effective length of the conductor.

With reference to FIGS. 5-7, several embodiments of a sensitive strain-based approach to monitoring SOC are shown. Two cells 32 are shown in end view with a spacer 34 positioned therebetween. In the example shown in FIG. 5, the strain gauge 36 is attached to a cell 32 and a stress concentrator 42 is positioned between the cell 32 and the spacer 34 with the first, larger surface 44 contacting the spacer 34 and the second, smaller surface 46 contacting the strain gauge 36. In the example shown in FIG. 6, the strain gauge 36 is attached to the spacer 34 and the orientation of the stress concentrator 42 is reversed such that the first, larger surface 44 contacts the cell 32 and the second, smaller surface 46 contacts the strain gauge 36.

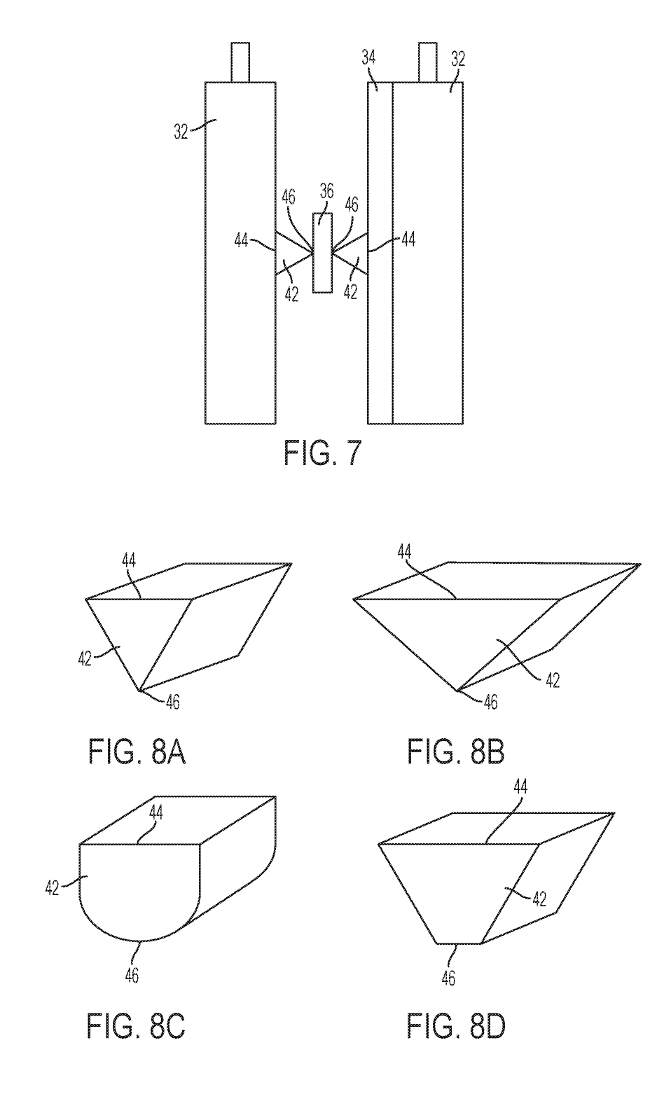

In the embodiment shown in FIG. 7, the strain-based SOC monitoring system includes two stress concentrators 42 configured to contact a strain gauge 36. For example, a stress concentrator 42 may be attached at the first, larger surface 44 to a cell 32 and an opposing spacer 34 and each second, smaller surface 46 may be configured to contact the strain gauge 36. By having two stress concentrators 42 amplifying the pressure on the strain gauge 36, the strain gauge 36 may be even more sensitive to the deformation of the cells 32 in the battery module 30 and allow more accurate monitoring of the SOC and/or cell expansion. The components shown in the Figures are not to scale, and the strain gauge 36 and stress concentrator(s) 42 may be enlarged for illustrative purposes.

While the stress concentrators 42 are shown in FIGS. 4-7 as coming to a point at the second surface 46, other configurations and shapes may be used. Any shape or geometry in which the second surface 46 has a smaller area than the first surface 44 or a surface area of the adjacent cell wall (e.g., wall 38) may provide a stress amplifying or concentrating effect. In general, the stress amplification or concentration may be proportional to the ratio of the first, larger surface 44 or the area of the adjacent cell wall to the second, smaller surface 46. However, there may be other factors that affect the degree of amplification, such as deformation of the spacer or stress concentrator. Several examples of stress concentrator shapes are shown in FIGS. 8A-8D, however, these shapes are not intended to be limiting.

FIGS. 8A and 8B show two different triangular stress concentrators 42. Both stress concentrators may have a pointed second surface 46, however, they may have different sized first surfaces 44. As shown, the stress concentrator 42 in FIG. 8B may have a wider first surface 44 than the stress concentrator 42 in FIG. 8A. Accordingly, if the stress concentrators have the same length dimension (e.g., into/out of the page), the first surface 44 of the stress concentrator in FIG. 8B will have a larger area than the stress concentrator in FIG. 8A. In some instances, the stress concentrator is FIG. 8B may amplify the stress by a greater multiplier compared to the stress concentrator in FIG. 8A since a larger first surface 44 may transfer more force. For example, a larger first surface 44 may be less sensitive to factors that reduce force transfer, such as deformation of other cell components.

FIG. 8C shows an example of a stress concentrator 42 having a rounded second surface 46. Accordingly, since only a portion of the rounded second surface 46 may contact the strain gauge 36, the area of contact may be reduced compared to the area of the first surface 44 and the stress may be amplified at the second surface 46. FIG. 8D shows an example of a stress concentrator 42 having a flat second surface 46. In the embodiment show, the stress concentrator 42 has a cross-section shaped as a truncated triangle. Since the area of the second surface 46 is smaller than the area of the first surface 44, the stress may be amplified at the second surface 46. While stress concentrators are shown with the first surface 44 being larger (e.g., by area) than the second surface 46, in other embodiments the surfaces 44 and 46 may have a same or similar area. For example, the stress concentrator 42 may be a rectangular prism. The surface 44 may be smaller than the area of the component it is attached to, such as a cell wall 38 or a surface 40 of a spacer 34. While several shapes have been shown and/or described, the stress concentrator may have any shape, such as cubic, spherical, or other generally prismatic shapes.

FIGS. 8A-8D show the perspective views of several stress concentrator embodiments. Accordingly, for stress concentrators having a pointed tip (e.g., FIGS. 8A and 8B), the second surface 46 may be substantially linear or two-dimensional. Of course, the tip of the stress concentrator has a nominal width, so the surface is not two-dimensional in the literal sense. While the triangles are shown as pointed, the tips of the triangles (e.g., the tip at the second surface 46) may be rounded or blunted. In the example shown in FIG. 8D, the second surface 46 may be more flat and planar, having a well-defined length and width. In the example shown in FIG. 8C, the second surface 46 may be substantially two-dimensional or planar, depending on the radius of the curve. For a very sharp curve (low radius), the surface 46 may be similar to a pointed stress concentrator, whereas a surface 46 with relatively shallow curve (large radius) may have more contact area and be similar to a planar stress concentrator.

In at least one embodiment, a ratio of the area of the first surface 44 of the stress concentrator 42 to the area of the second surface 46 of the stress concentrator 42 may be at least 2:1, for example, at least 3:1, 5:1, 10:1, 25:1 or 50:1. In another embodiment, a ratio of the area of the adjacent cell wall 38 to the area of the second surface 46 of the stress concentrator 42 may be at least 2:1, for example, at least 3:1, 5:1, 10:1, 25:1, 50:1, 100:1, or 500:1. Stated as ranges, a ratio of the area of the first surface 44 of the stress concentrator 42 or the area of the cell wall 38 to the area of the second surface 46 of the stress concentrator 42 may be from 2:1 to 50,000:1, or any sub-range therein, such as 2:1 to 25,000:1, 10:1 to 10,000:1, 10:1 to 5,000:1, 10:1 to 1,000:1, 10:1 to 500:1, 10:1 to 250:1, 25:1 to 250:1, 25:1 to 100:1, 5:1 to 100:1, or others. As described above, the ratio of the first surface area or the wall surface area to the second surface area may be proportional to the stress amplification by the stress concentrator 42. Accordingly, in at least one embodiment, the stress concentrator 42 may amplify or concentrate the stress exerted on the strain gauge by the deformation of one or more cells by the ratios by the same ratios as above (e.g., at least 2:1, 3:1, 5:1, 10:1, 25:1, or 50:1).

In another embodiment, the first surface 44 may have a long axis (e.g., length) that is the same or smaller than a width and/or length of the strain gauge 36. For example, the first surface 44 may have a long axis (e.g., length) that is from 50% to 100% of a width and/or length of the strain gauge 36, or any sub-range therein, such as 60% to 100%, 70% to 100%, 80% to 100%, 90% to 100%. In another embodiment, the first surface 44 may have a long axis (e.g., length) that is smaller than a width and/or length of the strain gauge 36. For example, the first surface 44 may have a long axis (e.g., length) that is from 50% to 95% of a width and/or length of the strain gauge 36, or any sub-range therein, such as 60% to 95%, 70% to 95%, 80% to 95%, 90% to 95%.

As described above, a battery module 30 may include a plurality of cells 32. In one embodiment, a strain gauge 36 may be positioned between each set of directly adjacent cells 32 (e.g., as shown in FIGS. 5-7). In some embodiments, multiple strain gauges 36 may be positioned between adjacent cells 32 (e.g., between some or all adjacent cells). However, in at least one embodiment, there may be less than one strain gauge 36 for each pair of adjacent cells 32. Since stress may mechanically transfer from one cell to another within a module or a pack, a single strain gauge 36 may be able to monitor the deformation of more than two cells 32.

In one embodiment, strain gauges 36 may be distributed throughout the module or the pack such that there is one strain gauge 36 for a certain number of cells 32. For example, a ratio of strain gauges to cells may be determined for a given battery module or pack, such as 1:4 (e.g., 1 strain gauge for every 4 cells). Therefore, in a battery module or pack having 12 cells, there may be three strain gauges distributed within the battery module or pack. For the same battery pack or module, a ratio of 1:6 would mean there would be two strain gauges distributed within the battery pack or module. In the example with 12 cells and a 1:4 ratio, for example, one strain gauge 36 may be placed between the first pair on each end of the module (e.g., in a single-file configuration) and the third may be placed in the middle of the module (e.g., between the 6^{th} and 7^{th} cell). In another embodiment, the strain gauges may be equally spaced or distributed throughout the module or pack (e.g., not necessarily between the end pairs). In one embodiment, the ratio of cells to strain gauges may be at least 2:1, for example, at least 3:1, 4:1, 5:1, 7:1, 10:1, 15:1 or 20:1. For example, the ratio of cells to strain gauges may be from 1:1 to 20:1, or any sub-range therein, such as 2:1 to 20:1, 2:1 to 10:1, 4:1 to 15:1, or 4:1 to 10:1.

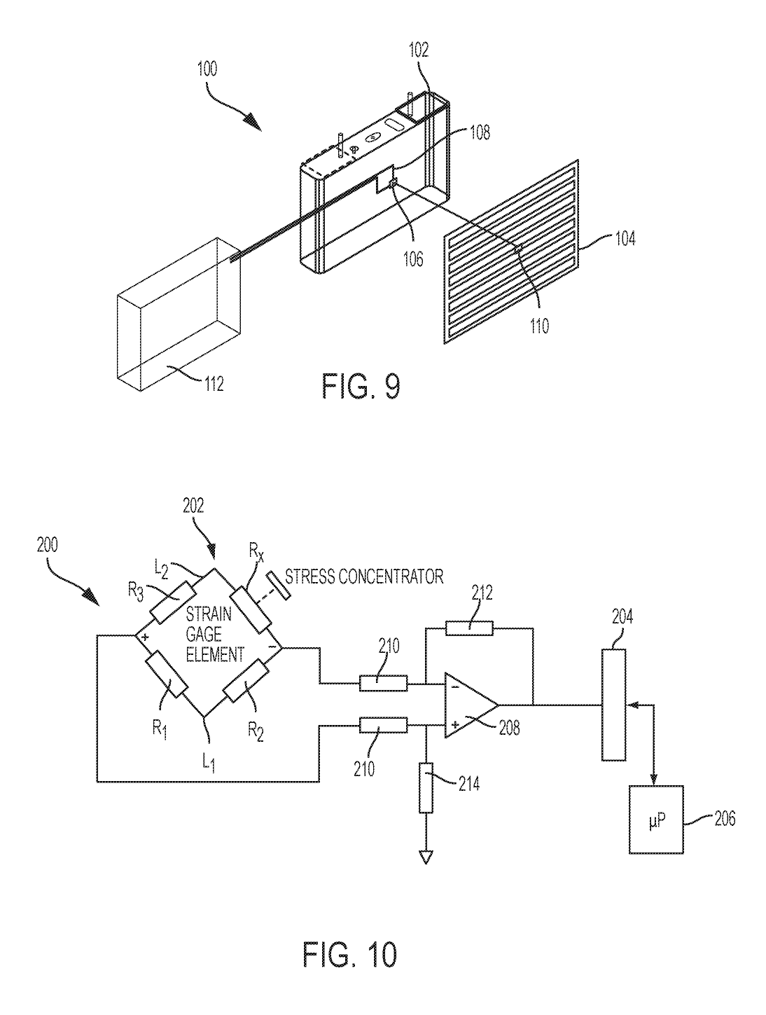

With reference to FIG. 9, an exploded schematic of a strain-based SOC monitoring system 100 is shown. The system 100 may include one or more prismatic cells 102, only one cell 102 is shown for simplicity. A spacer 104 may be included to separate adjacent cells 102. As described above, a strain gauge 106 may be positioned between the cell 102 and the spacer 104. In the embodiment shown, the strain gauge 106 is attached to a wall 108 of the cell 102, however, it could also be attached to the spacer 104. A stress concentrator 110 may be positioned between the strain gauge 106 and the spacer 104 (or between the strain gauge and the cell wall). As described above, the stress concentrator 110 may have an end with a smaller area and an end with a larger area and the end with the smaller area may be in contact with the strain gauge 106.

The strain gauge 106 may be in communication with a controller 112, which may be a battery energy controller module (BECM). The communication may be wired (e.g., through electrical wires) or wireless (e.g., RF, Bluetooth, etc.). If there are a plurality of strain gauges 106 in the system 100, they may each be in communication with a controller 112 (e.g., a single, common controller or separate controllers). The controller(s) 112 may be configured and programmed to receive data from the strain gauge representing the strain at its location within the battery pack. The data may be strain data or data that can be analyzed to determine strain (e.g., resistance). The strain determination may be performed by the controller 112 or it may receive the strain data.

In one embodiment, the strain data may be generated using a Wheatstone bridge 202. A schematic diagram of an electrical system/circuit 200 including a Wheatstone bridge 202 and configured to generate and/or analyze strain data is shown in FIG. 10. The operation of a strain gauge and a Wheatstone bridge is known to those of skill in the art and will not be described in detail. In brief, a Wheatstone bridge is an electrical circuit that may be used to measure an unknown electrical resistance (e.g., a strain gauge element) using additional resistors having a known resistance. The Wheatstone bridge 202 may include resistors of known resistance, R1, R2, and R3, and a resistor of unknown resistance Rx (e.g., the strain gauge element). One of the known resistors may be adjustable (e.g., R2).

The resistors may be divided into two legs, L1 and L2. If the ratio of the two resistances in the known leg is equal to the ratio of the two in the unknown leg, then the voltage between the two midpoints will be zero and no current will flow through a connected galvanometer (not shown). If the bridge is not balanced, the resistance of one of the resistors may be varied (e.g., R2) until the bridge is balanced. Alternatively, if there are no adjustable resistors in the bridge, either the voltage difference across the meter or the current flow through the meter may be used to calculate the value of the unknown resistance.

The system 200 may include other components, such as and analog to digital converter 204, a microprocessor 206, and a differential amplifier 208. Additional resistors may be included in the circuit, such as input buffer source resistors 210, a feedback resistor 212, and a pulldown divider resistor 214. Of course, the components shown and described are examples, and one of ordinary skill in the art will understand that components may be added, removed, relocated, or modified. The components other than the strain gauge (Rx) may located remotely from the battery cell(s), for example, they may be part of a BECM or another controller.

Accordingly, strain-based SOC monitoring systems are disclosed that may detect deformation of battery cells with a very high degree of sensitivity. One or more strain gauges may be attached to the external walls of a Li-ion cell and/or onto a spacer between cells. The sensitivity may be improved with the use of a stress concentrator to amplify the stress generated by the deforming cells due to charge and discharge. The strain gauge(s) may be positioned at various locations within the module or pack arrays. A strain gauge may be positioned between each pair of adjacent cells or there may be one strain gauge for a given number of cells.

The average change in resistance may be correlated with a battery SOC during calibration tests. For example, the calibration tests may include repeated cycling of the battery pack/cell SOC and monitoring the resistance and/or deformation. The cycling may be from 0% to 100% or other ranges. For example, the SOC could by cycled to above 100% (e.g., overcharge), such as to 125% or 150%. The SOC may also be cycled to a minimum that is greater than 0%. The resistance/deformation may be correlated to the SOC using other SOC monitoring techniques, such as Coulomb counting/integration and/or voltage-based methods. For example, Coulomb counting may be used in the middle of the SOC-voltage curve and voltage curves may be used at low and high ends of the SOC-voltage curve. Once a calibration curve is established and recorded, the strain gauge response(s) may be monitored in real time by a BECM or other controller to assess the battery SOC. The monitored SOC may then be used by the BECM to assess SOC, cell expansion, and/or cell pressure based on the stored calibration table or curve. The strain-based approach may be used either in place of, or in addition to, other methods, such as Coulomb integration or voltage measurements.

In order to understand the output of the instrumentation amplifier circuit including a Wheatstone bridge followed by a differential amplifier, whose output may be read by an A/D converter, the relationship of SOC to strain (e.g., as measured by the strain gage element in FIG. 10) may need to be understood. In addition, the relationship of strain to the resistance of the strain gage element and, ultimately, the A/D reading on the signal from the differential amplifier may also need to be understood. One skilled in the arts may select a strain gage whose resistance with no stress is represented as Rᵢₙᵢₜ. The change in resistance from no-stress to full stress (e.g., at a cell overcharged to 150% of rated capacity) can be represented as Delta_R. For example, one design of the Wheatstone bridge may be to set R1, R2, and R3 to Rᵢₙᵢₜ. The output of the differential amplifier may be a specific number of A/D counts (A2D_INITIAL) when the strain gage has a resistance of Rᵢₙᵢₜ, which it may at low SOCs for the cell.

As the cell approaches 100% SOC, the strain will increase and the resistance of the strain gage element will change away from Rᵢₙᵢₜ. As charging progresses, the strain gage will change to (Rᵢₙᵢₜ+Delta_R). At a cell SOC of 150%, the A/D counts may change by A2D_DELTA. The gain of the differential amplifier may be selected to attain a large enough A2D_DELTA to have an acceptable signal to noise ratio. Accordingly, based on the present disclosure, one of ordinary skill in the arts may select an appropriate strain gage, Wheatstone bridge circuit, and a correct differential amplifier circuit in order to have an acceptable change in A/D counts, which may lead to an adequate resolution for the overall system. Adequate resolution may mean that the reading from the strain gage from no stress to full stress (corresponding to A2D_INITIAL to A2D_INITIAL+A2D_DELTA) is a large change in A/D counts compared to the noise factors in the system.

Then, the calibration consists of recording A/D counts for known SOC values for the cell, and creating a lookup table from A/D counts back to known SOC's. When the SOC of the cell is low, large changes in the A/D counts are not expected, so this system may not be very sensitive in the range of low SOC's. However, when the cell SOC exceeds for instance 80%, the stress concentrator leads to a measurable strain on the gage, which can be read by the A/D. So at high SOC's for example above 80%, discernable changes in the A/D counts may be seen. So this lookup table later can be used to good effect in measuring SOC's, for instance above 80%.

In addition, to SOC monitoring, the strain gauge data may be used to monitor changes in the cell(s) over time, such as the state of health (SOH) of the cells/pack. For example, the strain gauges may be able to detect slow increases (e.g., linear increases) in pressure or deformation over time due to cell degradation. In such a case, a slow deviation of the strain gauge response outside the calibration curve limits may indicate excessive cell expansion due to gas generation and/or pressure buildup. Upon detection of the expansion, the system may prompt the BECM or another controller to take action to protect the battery, such as readjusting power limits, providing notification to the driver or a technician, or triggering a soft or hard alarm.

The disclosed systems and methods may enable more accurate battery pack operation between SOC limits, optimize battery usage, help maintain SOH, and improve customer satisfaction. Alternatively, the disclosed system and methods may be used as development tools integrated to test equipment. In this case, the disclosed system and methods can lead to refined battery testing methods and/or the development of improved batteries or cell management strategies.

Furthermore, the disclosed system and methods may allow for improved utilization of the full capacity of a battery. This is possible because they allow usage near the true 100% and 0% charge capacities, without concerns about exceeding the cell capability. In turn, this may allow for the use of a lower cost, lighter, and/or smaller battery for a given vehicle application. The use of pressure measurement in the disclosed system and methods may provide for additional simplification and cost reduction in the cell voltage measurement electronics, as the pressure can be used as a redundant and independent backup indicator.

The disclosed system and methods may be complementary to Coulomb integration or voltage measurement based sensing techniques. For example, if a cell voltage read system fails, a conventional system may initiate a timer to shut down the battery. This timer delay may be included because the cell state is unknown in these failure circumstances. However, if there is a measurement of pressure which covers groups of cells, then it may be possible to have knowledge of the cell state. For example, by knowing the pressure, it may be possible to know that the cells are not about to fail, and whether they are being damaged by their usage. This may allow a vehicle to travel farther when an error occurs in one of the SOC systems, since the strain-based measurement can sense if damage is occurring.

The disclosed system and methods may provide a complementary SOC measurement based on the fact that electrodes experience volume changes upon charge and discharge. These volume changes may create a pressure-correlated stress field on the cells, which are measurable with strain gauge(s) and the disclosed stress concentrator(s). Based on a pre-determined pressure-SOC correlation curve, SOC can be estimated based on the measured volume changes. The strain gauge signal may be fed into the BECM, in addition to voltage and/or ampere-hour inputs, therefore providing for complementary and independent measurements that may be used for a more accurate SOC description and improved battery usage. In one embodiment, the pressure-SOC correlation curve may be adjusted based on the current temperature of the battery cells or pack. For example, temperature sensors, such as thermistors, may be included in the battery pack and may feed temperature data to the BECM. The BECM may then compensate for the temperature and adjust the SOC determination. Alternatively, multiple pressure-SOC correlation curves may be generated at different temperatures.

As described above, the disclosed system and methods may provide an indication of cell degradation. Cell degradation may be associated with electrolyte decomposition into gaseous products, which may lead to cell internal pressure buildup and gradual cell deformation. The pressure buildup may thus be expected to produce a characteristic irreversible shift (or offset) in the pressure-SOC correlation curve, which may otherwise be reversible. This shift or offset can be converted into a cell pressure and compared against a known cell vent pressure threshold (e.g., about 125 psig) to optimize battery management, such as the Limiting Operating Strategy (LOS). Voltage and/or ampere-hour based monitoring alone may not be suitable tools to assess electrolyte decomposition and predict cell venting. This approach may also identify or detect cell aging.

While the battery and SOC monitoring systems have been shown and described above with respect to prismatic cells, one of ordinary skill in the art will understand that, based on the present disclosure, other types of cells may also be used. For example, any combination of cylindrical, button, or pouch cells may replace some or all of the prismatic cells. One of ordinary skill in the art will understand, based on the present disclosure, that modifications to the SOC monitoring system may be made to accommodate different cell types. For example, a pouch cell may expand and contract to a larger degree than a prismatic cell. Accordingly, the SOC calibration curve may be based on the type of cell in the battery pack. The type of cell used in the battery pack may be stored in the BECM or elsewhere in the SOC monitoring system.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A battery pack, comprising:
first and second adjacent battery cells;
a strain gauge positioned between the first and second battery cells; and
a stress concentrator positioned between the strain gauge and one of the first and second battery cells;
the stress concentrator having a first surface contacting the strain gauge and a second surface opposite the first surface, the first surface having an area no greater than an area of the second surface.

2. The battery pack of claim 1, wherein a ratio of the area of the second surface to the area of the first surface is at least 2:1.

3. The battery pack of claim 1, wherein a ratio of an area of a cell wall adjacent to the second surface to the area of the first surface is from 10:1 to 50,000:1.

4. The battery pack of claim 1, wherein a long axis of the stress concentrator is the same or smaller than a length or a width of the strain gauge.

5. The battery pack of claim 1, further comprising a spacer positioned between one of the first and second battery cells and the strain gauge.

6. The battery pack of claim 5, wherein the spacer is positioned directly between one of the first and second battery cells and the second surface of the stress concentrator.

7. The battery pack of claim 5, wherein the spacer is positioned directly between one of the first and second battery cells and the strain gauge.

8. The battery pack of claim 1, wherein the stress concentrator is a triangular prism, a truncated triangular prism, a rectangular prism, a sphere, or a cylinder.

9. A battery pack comprising:
first, second, and third adjacent battery cells;
a strain gauge positioned between the first and second battery cells; and
a stress concentrator positioned between the strain gauge and one of the first and second battery cells;
the stress concentrator having a first surface contacting the strain gauge and a second surface opposite the first surface, the first surface having a smaller area than the second surface.

10. The battery pack of claim 9, wherein a ratio of the area of the second surface to the area of the first surface is at least 5:1.

11. The battery pack of claim 9, further comprising a spacer positioned between one of the first and second battery cells and the strain gauge.

12. The battery pack of claim 9, further comprising a second strain gauge positioned between the second and third battery cells.

13. The battery pack of claim 12, further comprising a second stress concentrator positioned between the second strain gauge and one of the second and third battery cells.

14. The battery pack of claim 9, further comprising at least six adjacent battery cells and a plurality of strain gauges, each strain gauge positioned between two of the at least six adjacent battery cells.

15. The battery pack of claim 14, wherein a ratio of battery cells to strain gauges is at least 2:1.

16. The battery pack of claim 14, wherein a ratio of battery cells to strain gauges is at least 5:1.

17. A strain-based state-of-charge monitoring system, comprising:
first and second adjacent battery cells;
a strain gauge and a stress concentrator positioned between the first and second battery cells;
the stress concentrator having a first surface contacting the strain gauge and a second surface opposite the first surface, the first surface having a smaller area than the second surface; and
a controller in communication with the strain gauge and configured to receive strain data therefrom.

18. The system of claim 17, further comprising at least five adjacent battery cells and a plurality of strain gauges, each strain gauge positioned between two of the at least five adjacent battery cells and in communication with a controller.

19. The system of claim 17, wherein the controller is configured to compare the strain data to a stored calibration curve or table.

20. The system of claim 19, wherein the controller is configured to estimate a battery SOC based on the strain data and monitor for battery cell degradation based on the strain data as a function of pressure.
